(19) United States
(12) Patent Application Publication
(10) Pub. No.: US 2026/0097928 A1
(43) Pub. Date: Apr. 9, 2026

(54) GATEWAY FOR ELEVATOR SYSTEM WITH DUAL CONTROL UNITS TO MANAGE POWER DRAIN FROM VOICE COMMUNICATIONS

(71) Applicant: OTIS ELEVATOR COMPANY, Farmington, CT (US)

(72) Inventor: Nishit Oza, North Andover, MA (US)

(21) Appl. No.: 18/909,344

(22) Filed: Oct. 8, 2024

(51) Int. Cl. B66B 7/06

(52) U.S. Cl. CPC B66B 7/064

(57) ABSTRACT

A network system for transmitting voice and elevator telemetry data, having: a gateway with gateway controllers including one or more gateway controllers to process the telemetry data and to process the voice data; a first battery that powers the gateway; a first cable, operationally coupled to the one or more gateway controllers and an elevator controller, wherein the first cable is configured to receive, from the elevator controller, the telemetry data and power to recharge the first battery; a PLC connector, operationally coupled to the one or more gateway controllers, an intercom in the elevator car via a connector cable, wherein the connector cable extends from the PLC connector, along a traveling cable, to the intercom, and the PLC connector is configured to receive the voice data from the intercom and transfer a portion of the power from the elevator controller to recharge a second battery mounted within the intercom.

### BACKGROUND

The embodiments described herein relate to an elevator system and more specifically to a gateway for an elevator system with dual control units to manage power drain from voice communications.

Elevator systems have gateways that enable sending telemetry data from elevator controllers to data centers. Elevator cars may have alarm panels that allow passengers to alert call centers about issues such as a stopped elevator. The gateways may utilize cables, such as ribbon cables, to connect to a Service Tool (SVT) port on the elevator controller. The SVT port is typically used by mechanics to communicate with the elevator controller using handheld test equipment. The SVT port may be a serial port, such as a DB-9 pin port, which provides an interface to gather elevator data from the elevator controller for mechanics test equipment or the gateway. The SVT port also provides 5V, 100 mA of power, from the elevator controller, for devices connected to it, such as the mechanic's test equipment or the gateway. The SVT port typically does not provide enough power for powering, e.g., an intercom in the elevator car and to process and transfer, to a call center, voice data such as voice calls made from passengers utilizing the intercom during an alert condition.

### BRIEF SUMMARY

Disclosed is a network system for transmitting voice data and telemetry data associated with an operation of an elevator car, the system comprising: a gateway including: a housing; a printed circuit board (PCB) within the housing; gateway controllers coupled to the PCB, including one or more gateway controllers to process the telemetry data and to process the voice data; a first battery that powers the gateway; a first cable, operationally coupled to the one or more gateway controllers and an elevator controller, wherein the first cable is configured to receive, from the elevator controller, the telemetry data and power to recharge the first battery; and a power line communication (PLC) connector, operationally coupled to the one or more gateway controllers, and an intercom in the elevator car via a connector cable, wherein the connector cable extends from the PLC connector, along a traveling cable, to the intercom, and wherein the PLC connector is configured to receive the voice data from the intercom and transfer a portion of the power from the elevator controller to recharge a second battery mounted within the intercom.

In addition to one or more aspects of the system or as an alternate, the first cable includes an SVT connector.

In addition to one or more aspects of the system or as an alternate, the gateway is without a dedicated power port that receives power from a wall outlet.

In addition to one or more aspects of the system or as an alternate, the first and second batteries are lithium-ion batteries.

In addition to one or more aspects of the system or as an alternate, the first cable is configured to receive 5 volts, 100 milliamps of the power from the elevator controller, and the first and second batteries are each configured to store 3450 milliamps-hours.

In addition to one or more aspects of the system or as an alternate, the system includes a modem, operationally coupled to the one or more gateway controllers, and configured to connect the gateway with a cloud service.

In addition to one or more aspects of the system or as an alternate, the system includes a display module, visible along the housing, that displays text indicative of a charge status of at least one of the first and second batteries, controller connectivity and network connectivity. In addition to one or more aspects of the system or as an alternate: the one or more gateway controllers includes a first gateway controller to process the telemetry data and a second gateway controller to process the voice data, wherein: the first gateway controller is continuously powered by the elevator controller via the first cable to process the telemetry data; and the second gateway controller is configured to operate in a wake mode when receiving and processing the voice data and otherwise to operate in a sleep mode.

In addition to one or more aspects of the system or as an alternate, the first gateway controller is configured to only charge the first battery while the second gateway controller is in the sleep mode.

In addition to one or more aspects of the system or as an alternate, the first gateway controller is configured to divide the power received from the elevator controller between the first and second batteries, so the first and second batteries charge to completion during the same timeframe, while the second gateway controller is in the sleep mode and the first gateway controller is powered by the elevator controller via the first cable to process the telemetry data.

Disclosed is a method of operating a network system for transmitting voice data and telemetry data associated with an operation of an elevator car, the method comprising: receiving and processing the telemetry data by one or more gateway controllers of a gateway, mounted to a printed circuit board (PCB) within a housing of the gateway, wherein the telemetry data is received over a first cable operationally coupled between the one or more gateway controllers and an elevator controller; receiving power via the first cable, from the elevator controller, to recharge a first battery mounted to the PCB, wherein the first battery is operationally coupled to the one or more gateway controllers mounted to the PCB; receiving and processing the voice data by the one or more gateway controllers mounted to the PCB, wherein the voice data is received over a power line communication (PLC) connector, operationally coupled to (i) the one or more gateway controllers, and (ii) an intercom in the elevator car via a connector cable extending from the PLC connector, along a traveling cable, to the intercom; and transferring, via the PLC connector, a portion of the power received from the elevator controller, to charge a second battery mounted to the intercom.

In addition to one or more aspects of the method or as an alternate, the first cable includes an SVT connector.

In addition to one or more aspects of the method or as an alternate, the gateway is without a dedicated power port.

In addition to one or more aspects of the method or as an alternate, the first battery is a lithium-ion battery.

In addition to one or more aspects of the method or as an alternate, the first cable is configured to receive 5 volts, 100 milliamps of power from the elevator controller, and the first and second batteries are each configured to store 3450 milliamp-hours.

In addition to one or more aspects of the method or as an alternate, the method includes connecting, via a modem operationally coupled to the gateway controllers, with a cloud service.

In addition to one or more aspects of the method or as an alternate, the method includes displaying, via a display module, text indicative of a charge status of at least one of the first and second batteries, controller connectivity and network connectivity. In addition to one or more aspects of the method or as an alternate, the one or more gateway controllers includes a first gateway controller to process the telemetry data and a second gateway controller to process the voice data, and the method includes: continuously powering the first gateway controller by the first battery to process the telemetry data; and operating the second gateway controller in a wake mode when receiving and processing the voice data and otherwise operating the second gateway controller in a sleep mode.

In addition to one or more aspects of the method or as an alternate, the method includes: charging the first battery only while the second gateway controller is in the sleep mode.

In addition to one or more aspects of the method or as an alternate, the method includes: dividing the power received from the elevator controller between the first and second batteries, so the first and second batteries charge to completion during the same timeframe, while the second gateway controller is in the sleep mode and the first gateway controller is powered by the elevator controller via the first cable to process the telemetry data.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows the elevator system with a gateway and intercom according to an embodiment;

FIG. 3 shows details of the gateway having dual processors, according to an embodiment;

FIG. 4 is a process map for charging batteries in the gateway and intercom according to an embodiment;

FIG. 5A is a process map showing the available power for the gateway based on utilization of the gateway battery for powering the first gateway processor when only telemetry data is being communicated by the gateway;

FIG. 5B is a process map showing the available power for the gateway based on utilization of the gateway battery for powering the first and second gateway processors when telemetry data and voice data are being communicated by the gateway;

FIG. 6A is a process map showing the available power for the intercom based on utilization of the intercom battery when no voice data is being generated;

FIG. 6B is a process map showing the available power for the intercom based on utilization of the intercom battery when voice data is being generated;

FIG. 7 is a flowchart showing a process of operating the gateway to power the first and second gateway processors and charge the first and second batteries; and

FIG. 8 shows an ecosystem for utilizing the system to complete a call between the intercom and a call center.

### DETAILED DESCRIPTION

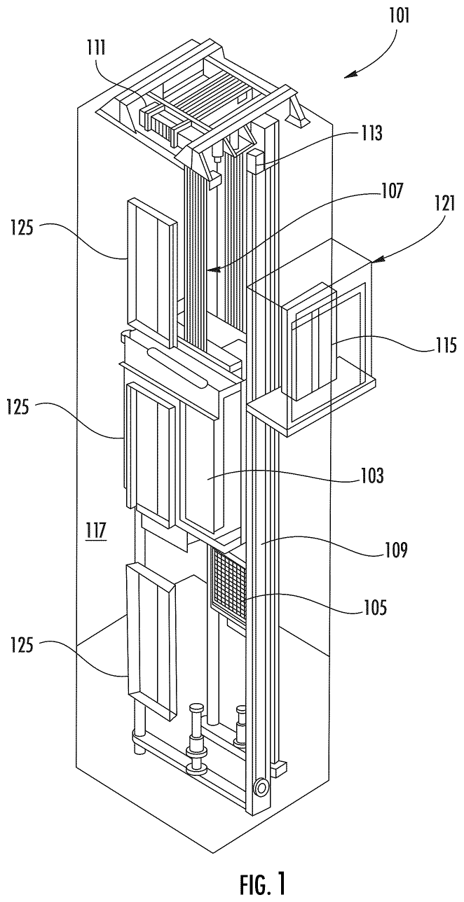

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The elevator controller 115 may be located, as shown, in a controller room 121 of the elevator shaft 117 and is configured to control the operation of the elevator system 101, and particularly the elevator car 103. It is to be appreciated that the elevator controller 115 need not be in the controller room 121 but may be in the hoistway or other location in the elevator system. For example, the elevator controller 115 may provide drive signals to the machine 111 to control the acceleration, deceleration, leveling, stopping, etc. of the elevator car 103. The elevator controller 115 may also be configured to receive position signals from the position reference system 113 or any other desired position reference device. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In one embodiment, the elevator controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

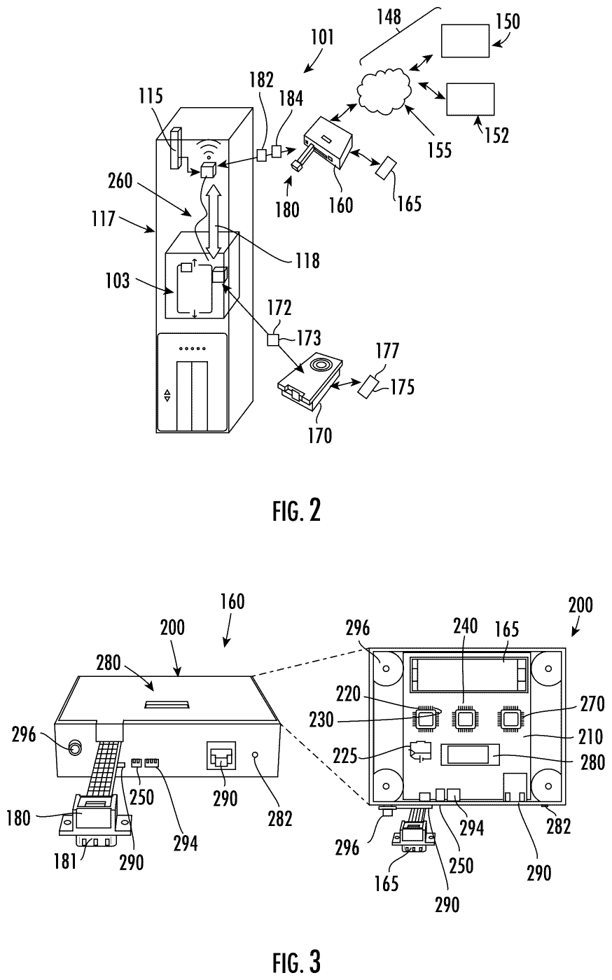

Turning to FIG. 2, the figure shows the elevator system 101 having the elevator car 103 and the elevator controller 115 in the hoistway 117. A gateway 160 may be operationally connected to the elevator controller 115 via a first cable 180. The gateway 160 may receive telemetry data 182 and other messages from the elevator controller 115. The gateway 160 may transmit the telemetry data 182 over a network 155 to a cloud service 148 that includes a data center 150. The gateway 160 may be powered by a first battery 165 that receives power 184 via the first cable 180 for recharging the first battery 165.

A traveling cable 118 is within the hoistway 117 and delivers power to the elevator car 103. An intercom (or ICU) 170 may be in the elevator car 103, which may be utilized by passengers in case of an alert condition. The intercom 170 may be powered by a second battery 175 that indirectly receives power for recharging from the elevator controller 115 (the batteries may be collectively referenced as 177). Specifically, a second cable 260 that runs along (e.g., is within) the traveling cable 118 may connect the gateway 160 and the intercom 170. Power from the elevator controller 115 may be directed through the gateway 160 to the intercom 170 to recharge the second battery 175. According to the embodiments, the intercom 170 is a digital intercom that is configured to transmit voice data 172, via the gateway 160, to a call center 152 that is part of the cloud service 148. The telemetry data 182 and voice data 172 may be collectively referred to as data 173.

The batteries 177 may be rechargeable lithium-ion batteries. Each of the batteries 177 may be able to store up to, for example, in only non-limiting embodiment, 3450 milliamp-hours (mAH) of charge. The 3450 mAh capacity for data and voice has been identified in one embodiment to provide a charge capacity nearly six times the battery capacity of 600 mAh for a data-only gateway often utilized in the industry. However other capacities may be selected within the scope of the embodiments. A cylindrical Li-Ion battery, rather than a flat pouch style Li-Ion battery used in mobile phones, is selected to avoid a swelling of the battery which may impact the operation of the flat pouch-type battery. However, this too is not intended on limiting the scope of the embodiments.

Power 184 available from the elevator controller 115 via the first cable 180 may be limited to, e.g., 100 milliamps at 5 volts, i.e., one half of a watt. This is exemplary only to show that the components may, in times of use, draw more power than can be continuously supplied by the controller. By code, the intercom 170 and gateway 160 should have enough battery backup power so that each may allow for the completion of four hours of talk time during a loss of electrical power to the elevator system possibly due to loss of power to the building.

Turning to FIG. 3, a configuration of the gateway 160 is shown to enable providing power to the gateway 160 and intercom 170, to charge the batteries 177 and achieve the four-hour talk time utilizing the available charging power from the elevator controller 115. In one embodiment, the gateway 160 may be without a dedicated power port of the type that connects with a NEMA (National Electrical Manufacturers Association) type power cord. That is, the gateway does not have or need traditional connection to wall outlets or wired power from the building power. The gateway 160 has a housing 200. A printed circuit board (PCB) 210 is within the housing 200.

Gateway controllers 220 are coupled to the PCB 210, including a first gateway controller 230 and a second gateway controller 240. A charging circuit 225 is also coupled to the PCB 210 and the gateway controllers 220. The first battery 165 that powers the gateway controllers 220 is mounted to the PCB 210. The first cable 180, as indicated, is operationally coupled to the first gateway controller 230, and the elevator controller 115. The first cable 180 may include an SVT (appliance) connector 181.

A power line communication (PLC) connector 250 is operationally coupled to the second gateway controller 240. The PLC connector 250 is also operationally coupled to the intercom 170 in an elevator car 130 via the second cable 260 extending from the PLC connector 250, along the traveling cable 118. The PLC connector 250 is configured to receive voice data from the intercom 170 and transfer a portion of the power 184 from the elevator controller 115 to recharge the second battery 175 mounted within the intercom 170.

A modem 270 may be within the housing and connected to the PCB 210. The modem 270 may be operationally coupled to the gateway controllers 220. The modem 270 may be configured to connect the gateway 160 with the cloud service 148, to transfer telemetry data 182 to the data center 150 and voice data 172 to the call center 152.

The gateway 160 may include a display module 280, visible along the housing 200. The display module 280 is configured to display text indicative of, e.g., a charge status of the batteries 177, device connectivity with e.g., the elevator controller 115 and the intercom 170, and network connectivity, e.g., over the network 155 with the cloud service 148. The display module 280 may include an actuator 282, which may be a button, for activating or deactivating the display module 280 or selecting different status indicators.

The gateway 160 may also include an ethernet port 290 as a backup for the modem 270, a USB port 292 for use by a maintenance worker to perform diagnostic test and provide additional power, and a CAN-BUS port 294 port for providing backup communications to the elevator controller 115. Magnets 296 maybe provided around the housing 200 for connecting the housing 200 to a metallic structure around or near the elevator controller 115. An antenna connector 298 may be provided for boosting the signal to and from the modem 270, depending on a location of the gateway 160.

As indicated, the first cable 180 is configured to receive, from the elevator controller 115, telemetry data 182, and power 184, e.g., the one half a watt, i.e., 100 milliamps at 5 volts, as indicated above, to recharge the batteries 177, e.g., to the capacity of 3450 mAh each. As indicated, these numbers are all exemplary, and not intended to limit the scope of the embodiments. Power available from the controller, capable of being stored by the batteries, and utilized by the processors, may be different (higher or lower) and fall within the scope of the disclosure. The power from the elevator controller 115 is directed through charging circuit 225 having a stepdown voltage that operates at 4.2 volts, increasing available current for charging the batteries 177 to above 110 milliamps.

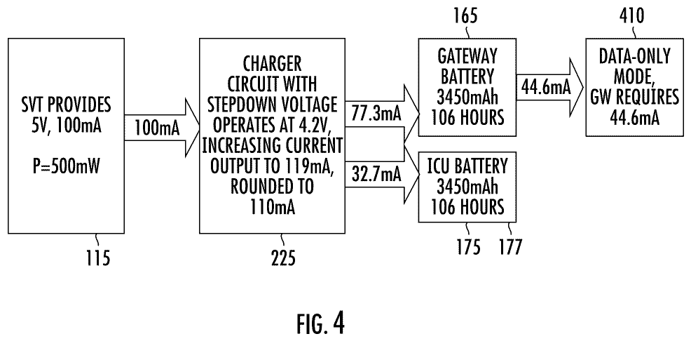

Turning to FIG. 4, as indicated, the elevator controller 115 provides 500 mW of power, i.e., 100 mA at 5V. 100 mA is passed through the charging circuit 225 to stepdown the voltage to 4.2V and increase the amperage to 110 mA. This may be divided between the batteries 177 to provide, e.g., 77.3 mA to the first battery 165 and 32.7m A to the second battery 175. This will charge these batteries 177, if not yet charged, to capacity in approximately 106 hours. The first battery 106 is constantly utilizing 44.6 mA (block 410) to power the first gateway controller 230 because telemetry data 182 is continuously sent to the data center 150. When no voice data 172 is being transmitted, the second gateway controller 240 and intercom 170 are asleep and the second battery 175 utilizes nominal power, i.e., 0.01 mA.

For example, the total current available is 110 mA. For the normal data-only operation, 44.6 mA are consumed and the gateway gets that. That leaves 65.4 mA of current available to charge both batteries. In the disclosed, non-limiting embodiment, a current distribution scheme is selected to provide equal amounts of current to each battery, i.e. 32.7 mA each. The ICU receives 32.7 mA, and the gateway receives 32.7+44.6 mA=77.3 mA. The gateway receives a greater amount of current, and to ensure the data-only operation receives priority before the battery charging allocation.

As indicated, these numbers are all exemplary, and not intended to limit the scope of the embodiments. Power available from the controller, capable of being stored by the batteries, and utilized by the processors, may be different (higher or lower) and fall within the scope of the disclosure.

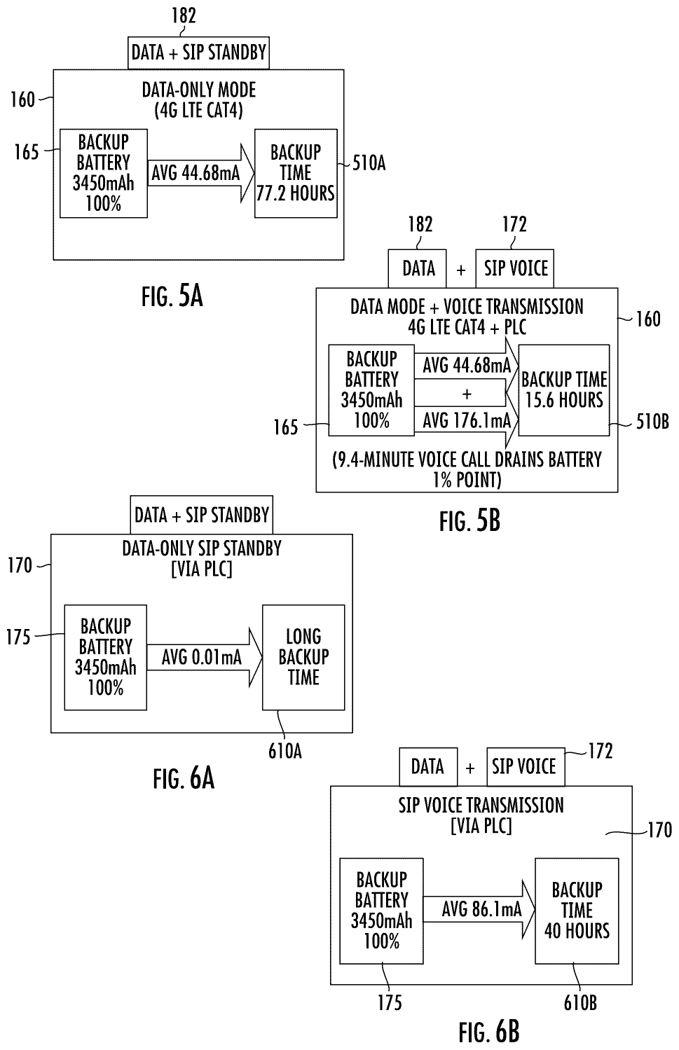

Turning to FIG. 5A, maximum available power from the first battery 165 in the gateway 160 will be considered if no power 184 was available from the elevator controller 115, e.g., during an emergency. When the gateway 160 is transmitting only telemetry data 182, there is a power consumption of 44.68 mA from the available 3450 mA in the first battery 165 to power the first gateway controller 230, and the gateway 160 may function for 77.2 hours as shown in block 510A. That is, FIG. 5A shows the system in a data-only mode, where power is utilized by the first processor and other components such as the modem. The second processor is effectively in sleep mode in the data-only mode.

As indicated, these numbers are all exemplary, and not intended to limit the scope of the embodiments. Power available from the controller, capable of being stored by the batteries, and utilized by the processors, may be different (higher or lower) and fall within the scope of the disclosure.

Turning to FIG. 5B, when the gateway 160 is transmitting both telemetry data 182 and voice data 172, there is a power consumption of 44.68 mA from the available 3450 mA in the first battery 165, to power the first gateway controller 230. There is also a power consumption of 176.1 mA from the available 3450 mA in the first battery 165 to power the second gateway controller 240. This is because the second gateway controller 240 requires more power to process the voice data 172 than the first gateway controller 230 requires to process the telemetry data 182. That is, a 9.4-minute voice call drains the first battery 165 by 1 percentage point. Under these conditions, the gateway 160 may function for 15.6 hours.

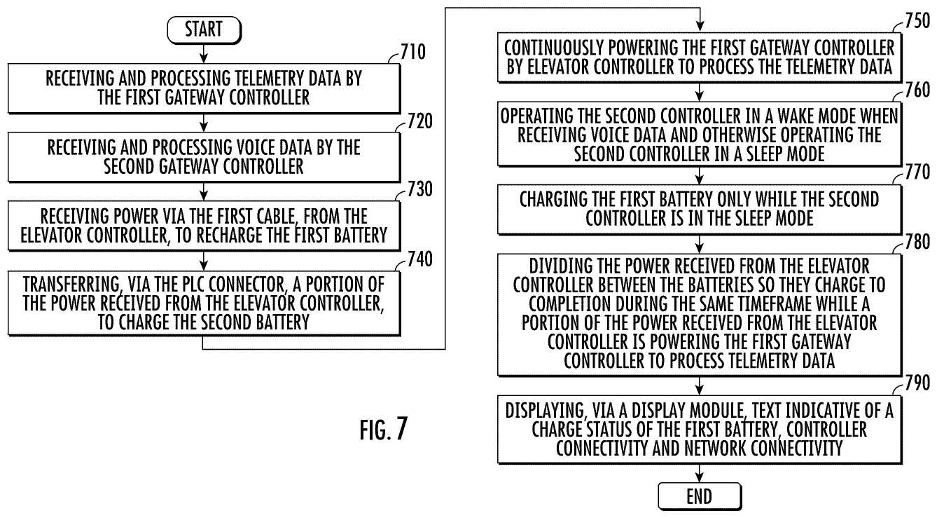

Turning to FIG. 6A, when the intercom 170 is not transmitting the voice data 172, there is a nominal power consumption of 0.01 mA from the available 3450 mA in the second battery 175. The intercom transmits a nominal amount of data when there is no voice call. This is typically not the same as telemetry data from the elevator controller. Rather the data from the intercom ensures the link between the gateway and the ICU is alive, albeit in sleep mode. That is, there is no elevator data gathered by the intercom like there is by the gateway, which is connected to the elevator controller. For example, there could be battery status information sent by the ICU to the gateway, so that it can be reported into the cloud service. Also, certain component failures in the ICU might be reported to the gateway, which could lead to an action required by a mechanic to resolve any issue with the ICU.

The second battery 175 will maintain charge for an extended period of time. As shown in FIG. 6B, when the intercom 170 is transmitting the voice data 172, there is a power consumption from the second battery 175 of 86.1 mA to power the intercom 170, such that the intercom will run for 40 hours.

Regarding charging of the batteries 177 when power 184 remains available from the elevator controller 115, to maximize battery charging and utilization, the second gateway controller 240 is configured to operate in a wake mode when receiving the voice data 172 and otherwise to operate in a sleep mode.

In the disclosed non-limiting embodiment, the gateway controller does not manage the battery charging. In one non-limiting example, the function of the gateway controller is to manage the elevator controller data and process the data so that it can be sent to the cloud service. The gateway controller requires 44.68 mA and consumes that much available power first. Leftover current is allocated and distributed by the battery management circuit 225 equally to the gateway battery and the ICU battery.

However, the first battery 165 will drain while the second gateway controller 240 is awake and voice data 172 is being processed by the second gateway controller 240. As shown in FIG. 5B, during the data and voice operation, the current consumption is 44.68 mA (data) and 176.1 mA (voice) which adds up to 220.78 mA, which is more than the 110 mA provided by the SVT port from the elevator controller. For this reason, during this period, power from the battery is utilized not changed.

It is noted that the controller power source provides the same power regardless of the mode the gateway is in. If the power need is below 110 mA, then that need will be met and the balance of the available power (in mA) will be utilized to charging the batteries. Battery charging can only occur when there is a power (in mA) surplus i.e. during the data-only mode (FIG. 5A). When voice is added (e.g., FIG. 5B), the surplus in available power becomes a deficit, and the gateway relies upon the power in the battery to complement the power from the SVT port.

That is, as indicated, the total current available is 110 mA. For the normal data only operation, 44.6 mA are consumed by the gateway, leaving 65.4 mA of current available to charge both batteries. The batteries are charged equally with the remaining power at, i.e. 32.7 mA. Thus, the ICU receives 32.7 mA, and the gateway receives 32.7 and 44.6 mA, or 77.3 mA. The gateway receives a greater amount of available charge during this operation to ensure the data-only operation has priority before the battery charging allocation. As indicated, while charging both batteries 177, available power is divided equally between the batteries 177, i.e., between the first gateway the first battery 165 and the PLC connector 250, to charge the second battery 175.

Turning to FIG. 7, a flowchart shows a process for powering the gateway to maximize battery charging and utilization. As shown in block 710, the method includes receiving and processing telemetry data 192 by the first gateway controller 230, via the first cable 180. As shown in block 720, the method includes receiving and processing voice data by the second gateway controller 240, via the PLC connector 250. As shown in block 730, the method includes receiving power via the first cable 180, from the elevator controller 115, to recharge the first battery 165. As shown in block 740, the method includes transferring, via the PLC connector 250, a portion of the power 184 received from the elevator controller 115, to charge the second battery 175. As shown in block 750, the method includes continuously powering the first gateway controller 230 by the elevator controller via the SVT port to process the telemetry data 182. As shown in block 760, the method includes operating the second gateway controller 240 in a wake mode when receiving and processing the voice data 172 and otherwise operating the second gateway controller 240 in a sleep mode. As shown in block 770, the method includes charging the first battery 165 only while the second gateway controller 240 is in the sleep mode. As shown in block 780, the method includes dividing the power received from the elevator controller 115 between the first battery 165 and the second battery 175, so the batteries 177 charge to completion during the same timeframe, while a portion of the power received from the elevator controller is powering the first gateway controller 230 to process the telemetry data 182. As shown in block 790, the method includes displaying, via a display module 280, text indicative of a charge status of the batteries 177, controller connectivity and network connectivity.

It is to be appreciated that that, in one embodiment, the gateway controller could manage battery charging. For example, the gateway controller could include the battery charging circuit, and in such embodiment, the gateway controller would include the functionality of the power management circuit.

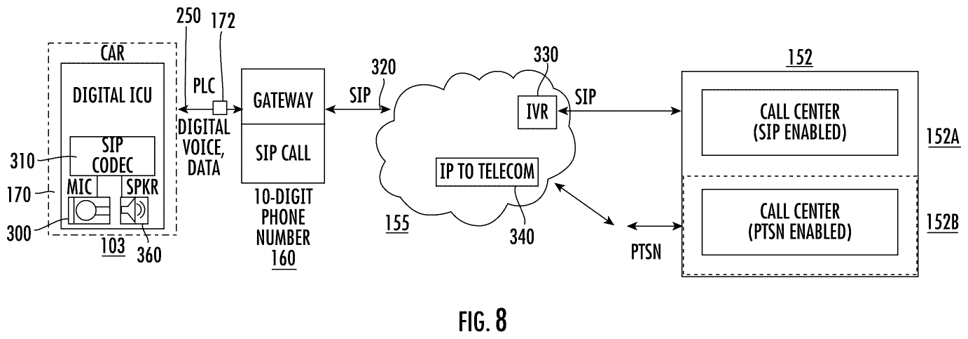

Turning to FIG. 8, an ecosystem is shown for completing a call from the intercom 170 in the elevator car 103 to the call center 152 over a network 155 utilizing the gateway 160. Two variations of the call center 152 are shown, including one call center 152A that is capable of utilizing IP protocols and another call center 152B that is capable of utilizing PTSN (public switched telephone network) protocols.

Voice is received by a mic 300 of the intercom 170, which is applied to an SIP (session layer) codec 310 in the intercom 170 to generate the voice data 172. Regarding the SIP codec 310, the codec is a type of audio codec used for Voice over Internet Protocol (VoIP) calls, such as completed in FIG. 8. One readily available codec that is efficient and provides high-quality voice, is Opus, a variant of Silk (by Silk Technologies, Inc., available on the Azure Marketplace) used by Skype and Teams (by Microsoft).

The voice data 172 is transferred over the PLC connector 250 to the gateway 160. The gateway 160 initiates a SIP call 320 over the network 155. A ten digit phone number is associated with the SIP call to identify its origin, i.e., the specific elevator car 103 associated with the call, to support PTSN calls. If the call center 152A supports calls over IP, then remaining with the SIP call, the call passes through SIP systems in the network such as an IVR (interactive voice response) technology or Session Border Controller (SBC) 330 and is completed at the call center 152A. It is noted that the figure shows an IVR because that is one configuration that has been utilized in North America. However, the utilization of IVR is not a requirement of the disclosure. Technically, the transmitted data in the SIP stays in an IP format if the call center is IP enabled.

If the call center 152B does not support calls over IP, but supports PTSN protocols, then the call is switched to the PTSN 340 and is completed at the call center 152B. As indicated, the call center 152B may utilize the ten-digit number assigned by the gateway 160 to directly contact the elevator car 103. Persons at the call center 152 may communicate with passengers in the elevator car 103 via a speaker 360 in the intercom 170. With the above disclosed operation of the gateway 160 and intercom 170, the call lasting many hours can be reliably completed.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz - typically in the 769 - 935 MHz, 315 Mhz and the 468 Mhz frequency range. This spectrum band below 1Ghz is particularly useful for RF IOT (internet of things) applications. Other LPWAN-IOT technologies include narrowband internet of things (NB-IOT) and LTE Category M1 internet of things (LTE Cat M1 or LTE-M). Wireless communications for the disclosed systems may include cellular, e.g. 2G/3G/4G/5G (etc.). The above is not intended on limiting the scope of applicable wireless technologies.

Wired connections identified above may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a sever/client protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

As indicated, when data is transmitted over a network between end processors, the data may be transmitted in raw form or may be processed in whole or part at any one of the end processors or an intermediate processor, e.g., at a cloud service or other processor. The data may be parsed at any one of the processors, partially or completely processed or complied, and may then be stitched together or maintained as separate packets of information.

Each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

What is claimed is:

1. A network system for transmitting voice data and telemetry data associated with an operation of an elevator car, the system comprising:
a gateway including:
a housing;
a printed circuit board (PCB) within the housing;
one or more gateway controllers coupled to the PCB, configured to process the telemetry data and to process the voice data;
a first battery that powers the gateway;
a first cable, operationally coupled to the one or more gateway controllers and an elevator controller, wherein the first cable is configured to receive, from the elevator controller, the telemetry data and power to recharge the first battery; and
a power line communication (PLC) connector, operationally coupled to the one or more gateway controllers, and an intercom in the elevator car via a connector cable, wherein the connector cable extends from the PLC connector, along a traveling cable, to the intercom, and wherein the PLC connector is configured to receive the voice data from the intercom and transfer a portion of the power from the elevator controller to recharge a second battery mounted within the intercom.

2. The system of claim 1, wherein the first cable includes an SVT connector.

3. The system of claim 1, wherein
the gateway is without a dedicated power port that receives power from a wall outlet.

4. The system of claim 2, wherein
the first and second batteries are lithium-ion batteries.

5. The system of claim 4, wherein
the first cable is configured to receive 5 volts, 100 milliamps of the power from the elevator controller, and the first and second batteries are each configured to store milliamps-hours.

6. The system of claim 1, comprising
a modem, operationally coupled to the one or more gateway controllers, and configured to connect the gateway with a cloud service.

7. The system of claim 6, comprising
a display module, visible along the housing, that displays text indicative of a charge status of at least one of the first and second batteries, controller connectivity and network connectivity.

8. The system of claim 1, wherein:
the one or more gateway controllers includes a first gateway controller to process the telemetry data and a second gateway controller to process the voice data,
wherein:
the first gateway controller is continuously powered by the elevator controller via the first cable to process the telemetry data; and
the second gateway controller is configured to operate in a wake mode when receiving and processing the voice data and otherwise to operate in a sleep mode.

9. The system of claim 8, wherein
the first gateway controller is configured to only charge the first battery while the second gateway controller is in the sleep mode.

10. The system of claim 9, wherein
the first gateway controller is configured to divide the power received from the elevator controller between the first and second batteries, so the first and second batteries charge to completion during the same timeframe, while the second gateway controller is in the sleep mode and the first gateway controller is powered by the elevator controller via the first cable to process the telemetry data.

11. A method of operating a network system for transmitting voice data and telemetry data associated with an operation of an elevator car, the method comprising:
receiving and processing the telemetry data by one or more gateway controllers of a gateway, mounted to a printed circuit board (PCB) within a housing of the gateway, wherein the telemetry data is received over a first cable operationally coupled between the one or more gateway controllers and an elevator controller;
receiving power via the first cable, from the elevator controller, to recharge a first battery mounted to the PCB, wherein the first battery is operationally coupled to the one or more gateway controllers mounted to the PCB;
receiving and processing the voice data by the one or more gateway controllers mounted to the PCB, wherein the voice data is received over a power line communication (PLC) connector, operationally coupled to (i) the one or more gateway controllers, and (ii) an intercom in the elevator car via a connector cable extending from the PLC connector, along a traveling cable, to the intercom; and
transferring, via the PLC connector, a portion of the power received from the elevator controller, to charge a second battery mounted to the intercom.

12. The method of claim 11, wherein the first cable includes an SVT connector.

13. The method of claim 11, wherein the gateway is without a dedicated power port.

14. The method of claim 11, wherein the first battery is a lithium-ion battery.

15. The method of claim 14, wherein the first cable is configured to receive 5 volts, 100 milliamps of power from the elevator controller, and the first and second batteries are each configured to store 3450 milliamp-hours.

16. The method of claim 11, comprising connecting, via a modem operationally coupled to the gateway controllers, with a cloud service.

17. The method of claim 16, comprising
displaying, via a display module, text indicative of a charge status of at least one of the first and second batteries, controller connectivity and network connectivity.

18. The method of claim 11, wherein
the one or more gateway controllers includes a first gateway controller to process the telemetry data and a second gateway controller to process the voice data, and
the method further comprises:
continuously powering the first gateway controller by the first battery to process the telemetry data; and
operating the second gateway controller in a wake mode when receiving and processing the voice data and otherwise operating the second gateway controller in a sleep mode.

19. The method of claim 18, comprising:
charging the first battery only while the second gateway controller is in the sleep mode.

20. The method of claim 19, comprising:
dividing the power received from the elevator controller between the first and second batteries, so the first and second batteries charge to completion during the same timeframe, while the second gateway controller is in the sleep mode and the first gateway controller is powered by the elevator controller via the first cable to process the telemetry data.
